(19) United States
(12) Patent Application Publication
(10) Pub. No.: US 2008/0040195 A1
(43) Pub. Date: Feb. 14, 2008

(54) QUANTITATIVE ANALYSIS OF WEB PAGE CLUTTER THAT ACCOUNTS FOR SUBJECTIVE PREFERENCES

(75) Inventors: Koushik Deepak Narayana, San Francisco, CA (US); John Nathan Boyd, Sunnyvale, CA (US); Paul Sokha Kim, Morgan Hill, CA (US)

Correspondence Address: BEYER WEAVER LLP, P.O. BOX 70250, OAKLAND, CA, 94612-0250, US

(73) Assignee: YAHOO! Inc.

(21) Appl. No.: 11/464,146

(22) Filed: Aug. 11, 2006

(51) Int. Cl. G06F 17/30

(52) U.S. Cl. 705/10

(57) ABSTRACT

A method determines a usability measure for a web page. A representation of the web page is processed in view of a usability model. The usability indication is determined based on the processing step. The representation of the web page may include an indication of at least one of structural and visual elements. For example, the indication of structural elements may include a document object model of the web page. The usability model may be a statistical model, such as a linear regression model, that provides an estimate of a statistical relationship between the usability measure and a plurality of characteristics discernible from the representation of the web page.

### BACKGROUND

This invention relates to web page clutter and, more particular, to methods to determine a measure of clutter on a web page.

It can be important to make web pages easy and pleasing to use, which can be particularly important for web pages it is desired to monetize. This may include, for example, advertisement-containing web pages (of a so-called “web portal,” for example), for which an advertiser pays money when a user views the web page and activates a link of the advertisement. If such web pages are not easy and pleasing to use, the money-making potential of those web pages can be jeopardized. One conventional indication of whether a web page is easy and pleasing to use is called “clutter.”

The inventors have realized that, since a large influence to the indication of “clutter” is subjective, it would be desirable to include subjective evaluations of a web page to determine its clutter. However, it is often impractical to survey actual people to determine clutter for a particular web page.

### SUMMARY

A method determines a usability measure for a web page. A representation of the web page is processed in view of a usability model. The usability indication is determined based on the processing step. The representation of the web page may include an indication of at least one of structural and visual elements. For example, the indication of structural elements may include a document object model of the web page. The usability model may be a statistical model, such as a linear regression model, that provides an estimate of a statistical relationship between the usability measure and a plurality of characteristics discernible from the representation of the web page.

### BRIEF DESCRIPTION OF THE DRAWINGS

FIG. 1 broadly illustrates example processing to determine the usability model in accordance with one example.

FIG. 2 illustrates example processing to determine values for the characteristics of the web pages, for one particular web page.

FIG. 3 illustrates an example of processing to determine a usability measure for a web page, using the statistical model for usability and the determined values for characteristics of the web page.

### DETAILED DESCRIPTION

In accordance with an aspect, a usability model is determined by, for example, surveying users about the usability of a sampling of web pages. The usability model is then applied to another web page to determine a usability indication for that web page.

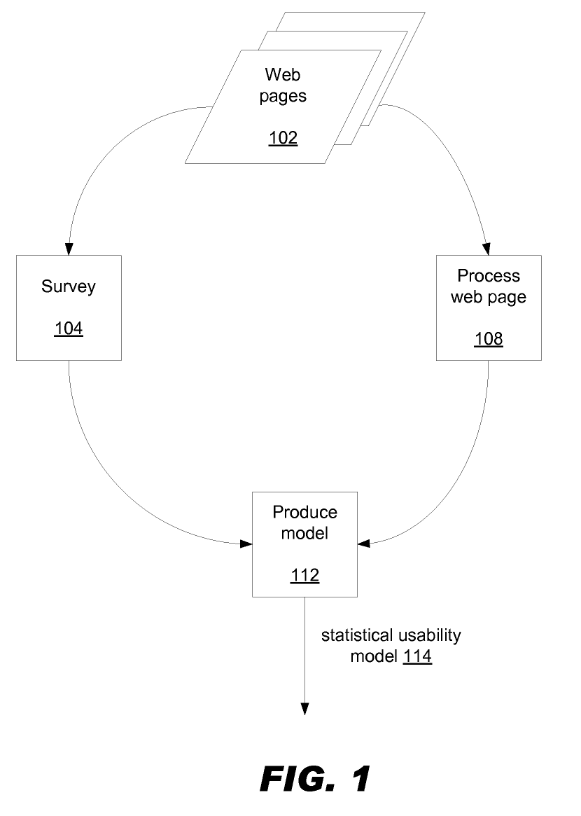

FIG. 1 broadly illustrates example processing to determine a usability model in accordance with one example. As shown in FIG. 1, a web page sample includes a plurality of web pages 102. The web pages 102 are provided to users in a survey 104. The output of the survey 104 is an indication of reactions 106 of the users to the web pages 102 of the web page sample.

In addition, representations of the web pages 102 of the web page sample are processed 108 to determine, quantitatively, characteristics of the web pages. The indication of user reactions 106 and values for the determined characteristics of the web pages 102 of the web page sample are processed to determine a statistical usability model 114, in view of the determined web page characteristics. The statistical usability model 114 is saved for use in determining a usability measure for another web page that is not one of the web pages 102 of the web page sample.

In one example, the statistical usability model 114 is a regression model. For example, the regression model may be a linear regression model characterized by linear coefficients.

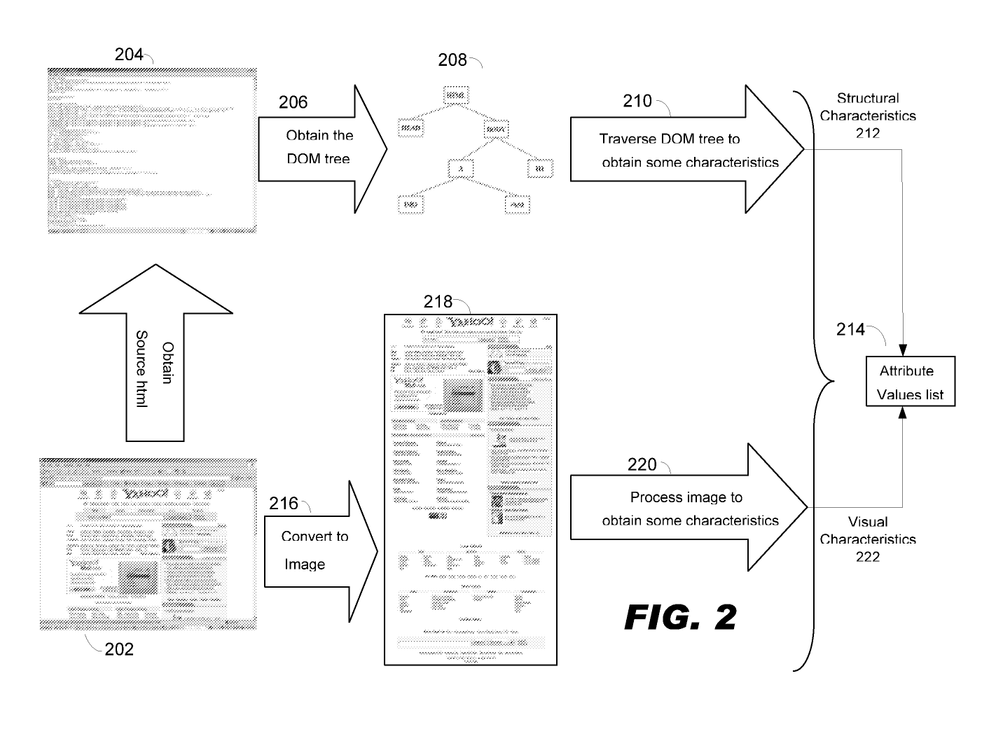

FIG. 2 illustrates a flowchart of example processing to determine values for the characteristics of the web pages, for one particular web page 202. The FIG. 2 processing may be used, for example, for step 108 of the FIG. 1 processing. In the FIG. 2 example, the characteristics are considered in two groups—structural characteristics and visual characteristics. For structural characteristics, in the FIG. 2 example, a source HTML representation 204 is used. Processing 206 is performed to obtain a Document Object Model (DOM) tree representation 208 of the web page 202. The DOM representation is a nominally platform- and language-neutral representation that allows programs to access information about the structure and style of documents. Processing 210 is performed (including traversing the DOM tree representation 208) to determine values for structural characteristics 212, and the determined values are added to an attributes values list 214.

In one example, the following structural characteristics are considered:
1. Total number of links
2. Total number of words
3. Total number of images (non-ad images)
4. Image area above the fold (non-ad images)
5. Dimensions of page
6. Page area (total)
7. Page length
8. Total number of tables
9. Maximum table columns (per table)
10. Maximum table rows (per table)
11. Total rows
12. Total columns
13. Total cells
14. Average cell padding (per table)
15. Average cell spacing (per table)
16. Dimensions of fold
17. Fold area
18. Location of center of fold relative to center of page
19. Total number of font sizes used for links
20. Total number of font sizes used for headings
21. Total number of font sizes used for body text
22. Total number of font sizes
23. Presence of “tiny” text
24. Total number of colors (excluding ads)
25. Alignment of page elements
26. Average page luminosity
27. Fixed vs. relative page width
28. Page weight (proxy for load time)
29. Total number of ads
30. Total ad area
31. Area of individual ads
32. Area of largest ad above the fold
33. Largest ad area
34. Total area of ads above the fold
35. Page space allocated to ads
36. Total number of external ads above the fold
37. Total number of external ads below the fold
38. Total number of external ads
39. Total number of internal ads above the fold
40. Total number of internal ads below the fold
41. Total number of internal ads
42. Number of sponsored link ads above the fold
43. Number of sponsored link ads below the fold
44. Total number of sponsored link ads
45. Number of image ads above the fold
46. Number of image ads below the fold
47. Total number of image ads
48. Number of text ads above the fold
49. Number of text ads below the fold
50. Total number of text ads
51. Position of ads on page

### This is an example, and fewer, more or other structural characteristics 212 may be utilized.

For visual characteristics, in the FIG. 2 example, processing 216 converts the web page 202 to an image representation 218 of the web page 202. The image representation 218 is processed 220 to determine values for visual characteristics 222, and the values are added to the attributes values list 214.

In one example, the following visual characteristics are considered (numbered sequentially from the last number of the structural characteristics):
52. Presence of animated/flashing ads
53. Average ad luminosity
54. Maximum ad luminosity
   Again, this is an example. Fewer, more or other visual attributes may be utilized.

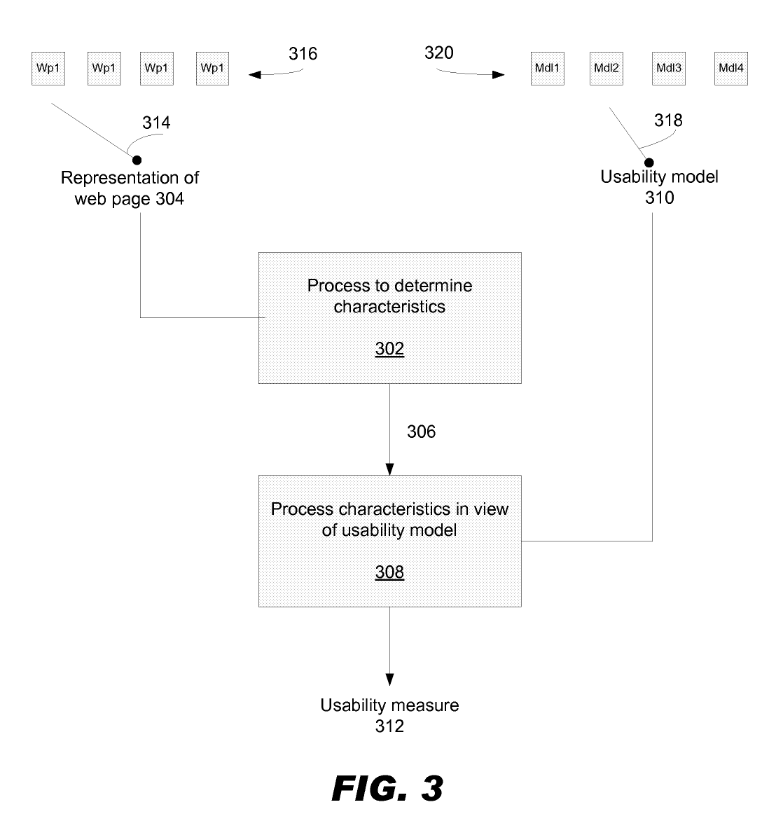

We have described how a statistical model for usability may be determined (FIG. 1) and, further, how a web page may be processed to determine values for the characteristics of the web pages (FIG. 2). We now describe, with reference to FIG. 3, an example of processing to determine a usability measure for a web page, using the statistical model for usability and the determined values for characteristics of the web page.

At step 302, a representation of the web page 304 is processed to determine characteristics 306 of the web page 304. The step 302 processing may be, for example, processing similar to that described with reference to FIG. 2. At step 308, the determined characteristics 306 of the web page 304 are processed in view of the usability model 310, to determine the usability measure 312. The usability model 310 may have been determined, for example, using processing similar to that described with reference to FIG. 1.

As for step 308, the processing may be, for example, processing to use a regression model, whether a linear or non-linear regression model. Other models may be utilized as well, as appropriate.

Furthermore, in some examples, various models and/or various web pages may be provided to the FIG. 3 processing. For example, the FIG. 3 processing may be a result of a program being executed on a general purpose computer. The program may include, or have accessible to it, user interface processing via which a user may interact with the program to indicate a particular web page and/or a particular model to be processed by the FIG. 3 processing.

In FIG. 3, a choice of web pages is indicated by the schematic switch 314, via which one of a plurality of web page representations (shown in FIG. 3 as web pages 316) may be provided as the web page representation 304 input to the step 302 processing. Furthermore, a choice of statistical usability models is indicated by the schematic switch 318, via which one of the plurality of statistical usability models (shown in FIG. 3 as models 320) may be provided as usability model 310 to the step 308 processing. In practice, the switch 314 and switch 318 would typically (but are not required to) be implemented via choices on a user interface of a software application on a general purpose local computer, server or distribution of computing power.

In one example, the usability indicator is utilized as a tool to improve the usability of a web page. For example, the usability indicator for a web page is characterized by sub-components that each correspond to the contribution of a separate attribute of the web page. For example, going back to the linear regression example, each subcomponent may be a product of a value associated with a particular attribute and a coefficient of the statistical usability model, also associated with that particular attribute. An examination of the sub-components, then, contributes to an evaluation of how the usability of the web page may be improved.

For example, if, the higher the usability indicator, the more “cluttered” a web page is deemed to be, then a particular attribute for which an associated coefficient of the statistical usability model is larger has a relatively larger contribution to the clutter. Put another way, if the value for the particular attribute can be lowered, then this will have a relatively larger effect on reducing the clutter.

It has been shown, then that a generally-applicable usability model may be determined. The usability model is then applied to another web page to determine a usability indication for that web page. Furthermore, if the usability model is determined based on subjective interpretations of usability with respect to particular web pages, then those subjective interpretations can be practically applied to web pages other than those particular web pages. This results in a measure of usability that, while determined in view of subjective criteria, is repeatable and is practically determined.

1. A method to determine a usability measure for a web page, comprising:
processing a representation of the web page in view of a usability model; and
determining the usability indication based on the processing step.

2. The method of claim 1, wherein:
the representation includes an indication of at least one of structural and visual elements.

3. The method of claim 2, wherein:
the indication of structural elements includes a document object model representation of the web page.

4. The method of claim 3, wherein:
processing the representation of the web page in view of a usability model includes traversing the document object model representation to determine the structural elements.

5. The method of claim 2, wherein:
the indication of visual elements includes an image representation of the web page.

6. The method of claim 5, wherein:
processing the representation of the web page in view of the usability model includes processing the image representation of the web page to determine the visual elements.

7. The method of claim 1, further comprising:
receiving an indication of the usability model, selected from a plurality of usability models.

8. The method of claim 7, further comprising:
providing a user interface configured to allow a user to make the selection of the usability model.

9. The method of claim 1, further comprising:
receiving a selection of the web page from a plurality of web pages.

10. The method of claim 9, further comprising:
providing a user interface configured to allow a user to make the selection of the web page.

11. The method of claim 1, further comprising:
receiving an indication of the usability model, selected from a plurality of usability models;
receiving an indication of the web page, selected from a plurality of web pages; and
providing a user interface configured to allow a user to make the selection of the usability model and of the web page.

12. The method of claim 1, wherein:
the usability model includes a statistical model that provides an estimate of a statistical relationship between the usability measure and a plurality of characteristics discernible from the representation of the web page.

13. The method of claim 12, wherein the statistical model is a linear regression model.

14. The method of claim 1, wherein:
the usability model includes a plurality of coefficients, each coefficient being a linear coefficient corresponding to a separate one of a plurality of characteristics discernible from the representation of the web page.

15. The method of claim 1, further comprising:
processing subcomponents of the usability indication, each subcomponent corresponding to a separate one of a plurality of characteristics discernible from the representation of the web page; and
based on the step of processing subcomponents of the usability indication, altering the design of the web page.

16. A computing device operable to perform the method of claim 1.

17. A computer program product, stored on a machine-readable medium, to generate a usability indication for a web page, the computer program product comprising instructions operable to cause a computer to
process a representation of the web page in view of a usability model; and
determine the usability indication based on the processing step.

18. A method to generate a usability model to analyze usability of a web page, comprising:
obtaining subjective reactions to a plurality of web pages with respect to perceived usability of the web pages; and
processing the obtained subjective reactions in view of a plurality of characteristics of the web pages to generate the usability model.

19. The method of claim 18, wherein:
the usability model is a statistical model that provides an estimate of a statistical relationship between the usability measure and a plurality of characteristics discernible from the representation of the web page; and
processing the obtained subjective reactions includes statistically determining a general function for the usability indication in view of variable characteristics of web pages.

20. The method of claim 18,wherein:
the usability model is a regression model; and
processing the obtained subjective reactions includes determining coefficients of the regression model for the characteristics of web pages.

21. The method of claim 18, wherein:
the usability model is a linear regression model; and
processing the obtained subjective reactions includes determining, for each separate one of the plurality of discernible characteristics, a respective corresponding coefficient for the linear regression model.

22. The method of claim 21, wherein:
the plurality of discernible characteristics includes structural characteristics.

23. The method of claim 21, wherein:
the plurality of discernible characteristics includes visual characteristics.

24. The method of claim 21, wherein:
the plurality of discernible characteristics includes visual and structural characteristics.
